(19) United States
(12) Patent Application Publication
(10) Pub. No.: US 2014/0120999 A1
(43) Pub. Date: May 1, 2014

(54) Gaming proxy mechanism

(71) Applicants: Gordon T. Graves, Austin, TX (US); Jeffery Hiser, Austin, TX (US)

(72) Inventors: Gordon T. Graves, Austin, TX (US); Jeffery Hiser, Austin, TX (US)

(21) Appl. No.: 13/998,429

(22) Filed: Oct. 31, 2013

Related U.S. Application Data
(60) Provisional application No. 61/795,998, filed on Oct. 31, 2012.

(51) Int. Cl. G07F 17/32

(52) U.S. Cl. CPC G07F 17/3286
USPC 463/19

(57) ABSTRACT

Described is a proxy mechanism for allowing a gaming system such as bingo to be played over the internet from a location situated outside a geographical area within which at least a portion of the gaming system is physically located. The proxy mechanism can include a proxy terminal located within the geographical area that communicates with both players located outside the area and the gaming system within the area.

### CROSS-REFERENCE TO RELATED APPLICATIONS

This application claims priority on U.S. Provisional Patent Application Ser. No. 61/795,998, filed Oct. 31, 2012.

### FIELD OF THE DESCRIBED MECHANISM

The described mechanisms and methods relate generally to electronic gaming apparatus and systems including electronic bingo games.

### BACKGROUND

In the gaming industry in general and in casino environments as well as internet applications in particular it is desirable to provide gaming systems including bingo apparatus and systems that are attractive for customers to play while providing an acceptable return to the proprietor of the gaming systems.

Regarding bingo games, most electronic bingo games are played in a similar manner to conventional bingo games where a player pays for and plays one or more bingo cards. Balls having marks or symbols corresponding to squares on the cards are sequentially drawn, or in the case of electronic systems, randomly generated. The first card in which a predetermined patterns of squares, such as columns, diagonals, rows or corners, is filled by symbols on the drawn balls is the winner. Typically, the prize is paid to the player with the winning card or if two or more cards have one of the predetermined patterns, the prize can be split. There are a number of variations on this approach especially in electronic implementations of bingo as described for example in U.S. patent application Ser. No. 13/507,344.

A number of problems can arise in implementing the bingo games as described above including geographical limitations on the customer base as well as various security concerns.

### SUMMARY

Described is a method of constructing an apparatus and method for expanding the customer base in a situation where jurisdictional requirements require players to be located in a specific geographical area as well as improved, reliability, and security of an online gaming system.

### BRIEF DESCRIPTION OF THE DRAWINGS

FIG. 1 is a block diagram of a multiplayer bingo gaming system suitable for utilizing the described proxy method;

FIG. 2 is a representation of a proxy terminal display help screen for use with the system of FIG. 1;

FIG. 2A is a expanded portion of the proxy terminal display help screen of FIG. 2;

FIG. 3 is a representation of a proxy terminal display game screen for use with the system of FIG. 1;

FIG. 3A is a expanded portion of the proxy terminal display game screen of FIG. 3;

FIG. 4 is a representation of a proxy terminal display player screen for use with the system of FIG. 1; and

FIG. 4A is a expanded portion of the proxy terminal display game screen of FIG. 4;

### DETAILED DESCRIPTION

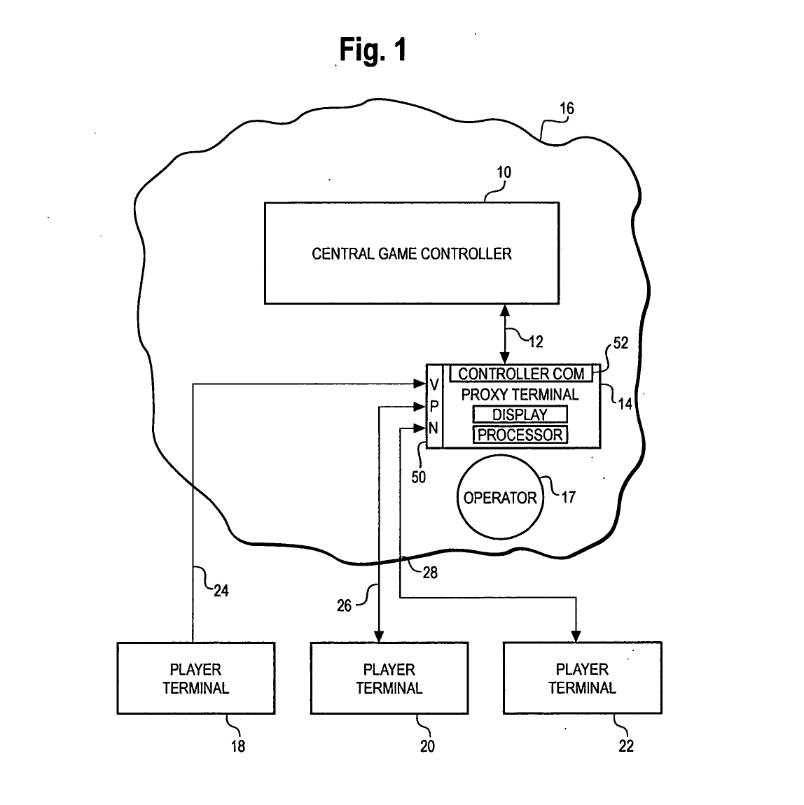

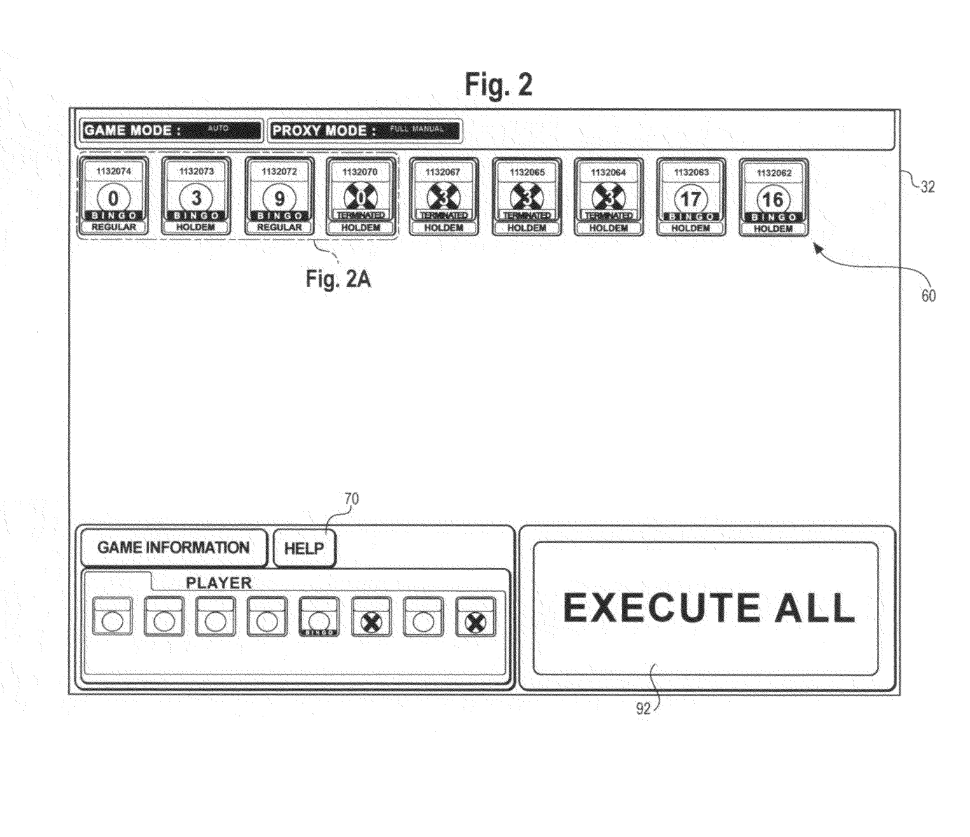

FIG. 1 is a block diagram of a multiplayer bingo gaming system that provides a representative example of an environment in which the below described bingo methods can be implemented. An example of such a system is the Bingo system described in U.S. patent application Ser. No. 13/507,344 which is herein incorporated by reference. In this example, a central game controller or server 10 is used to control the system. In a casino environment the controller 10 can be a central gaming system computer and in an internet application the controller 10 can be a system server. Connected to the central controller 10, as represented by a communication line 12 is, in this embodiment, is at least one proxy terminal represented by a block 14. The proxy terminal 14 can include a processor based on a conventional or commercially available internet enabled terminal or server utilizing a digital processor where control logic for operating said processor can be preferably implement using computer software. A human proxy terminal operator is represented by a circle 17. Preferably, the proxy terminal 14, as is conventional for many terminals, utilizes an internet enabled server. A specified geographical area represented as being within a line 16 contains the central game controller 10 and the proxy terminals 14 in the particular embodiment described herein. Connected to each proxy terminal 14 is a set of one or more player terminals, represented at 18-22. For the purposes of this description, the terminals are located outside of the specified geographical area 16. The terminals 18-22 can be of the type described in U.S. patent application Ser. No. 13/507,344. In this case the terminals are connected as functionally represented by a set of lines 24-28 to the proxy terminal 14. Preferably, the communication 24-28 with the proxy server 14 utilizes a closed, secure, encrypted proprietary network, hereafter referred to as a “tunnel” virtual private network or “Tunnel VPN,” over the Internet. As indicated at 50, the proxy terminal 14 can be configured to receive VPN signals from the player terminals 18-22. Also, as indicated at 52, the proxy terminal 14 can be configured for direct, non-internet connection with the game controller 10. Preferably, there will be no direct communication connection between the central game controller 10 and the player terminals 18-22 so that the players are unable to communicate with the central game controller 10.

The preferred embodiment of the Game System is in the nature of a linked electronic bingo system played within a licensed gaming facility located within the geographical area 16. The Game System consists of gaming network technology hardware and software components which allow individuals outside of the geographical area 16 to remotely participate in a conventional or regular bingo game or other types of bingo games such as “Bad Beat Bingo,” “Hold'em Bingo” and “Near Bingo” as described in U.S. patent application Ser. No. 13/507,344, that operate, for example, within a licensed Indian gaming facility located within the geographical area 16. Such remote participation can be achieved through the use of the game system components shown in FIG. 1 which facilitate participation by allowing proxy players 17, located inside the geographical area 16, to play the bingo game on behalf of the participants located outside the area 16 by communicating remotely with the proxy players via the Tunnel VPN over the Internet. The Game System hardware and software components can preferably include electronic proxy player stations, switches, database servers, game engines, web servers with Secure Socket Layer (SSL”) certificate, firewalls, routers, and a computer software program located on-site at the licensed Indian gaming facility. Here, the game participants can connect with the proxy terminal via the Tunnel VPN which can, for example, include the remote gaming website of a licensed Indian gaming facility by using their terminals that can include PCs, tablets and various smart phones. In this embodiment, the Central Game Controller 10 allows remote game participants at the terminals 18-20 to instruct the proxy player operator 17 to purchase up to nine bingo cards and allows the remote game participants at 18-20 to instruct the proxy player operator 17 to set on proxy terminal 14 varying denominations which the game participant chooses to wager per card for each round of three balls drawn.

Preferably all remote game participants will be required to register prior to commencing use of the game system of FIG. 1. As is conventional, remote game participants can be instructed to provide their name, address, date of birth, biometric authentication, username, password, and security questions. Also, in this embodiment the game participants can be provided with the option to provide the central game controller 10 with preferred proxy player default options or instructions. Upon completing registration, the remote game participant will receive a secure confirmation enabling activation of their account. Also, IP blocking software can be used to ensure the System accepts no players outside any other geographical jurisdiction such as a state.

In this embodiment the system of FIG. 1 can utilize the proxy play component with the game system. For example, the proxy play operator 17 can use the electronic proxy player station 14 to assist the proxy play operator 17 in playing bingo games by following the different instructions of many different remote game participants on the player terminals 18-20 who are not physically present in the gaming facility. The electronic proxy player station 14 monitors the bingo games for each game participant assigned to that particular electronic proxy player station. Here, the proxy play operator 17 can follow the specific instructions of the remote game participant unless Internet connection is lost. In the preferred embodiment the electronic proxy play station 14 has a feature that permits the proxy play operator 17 to follow the preset instructions that are accessible by the proxy terminal 14 of a game participant who loses his Tunnel VPN connection during the play of a specific bingo game. In this respect, the remote game participant can instruct the proxy play operator to follow one of several offered strategies whenever such connection is lost.

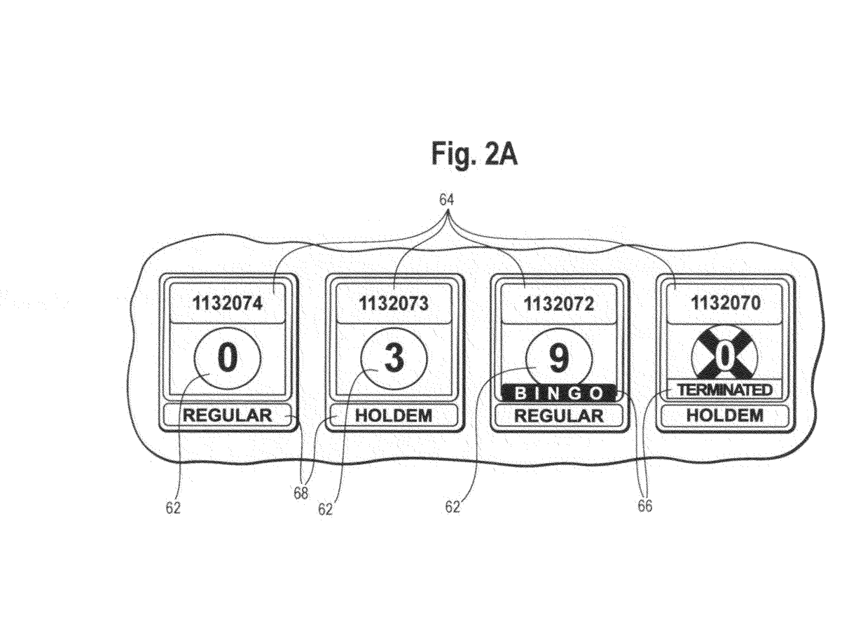

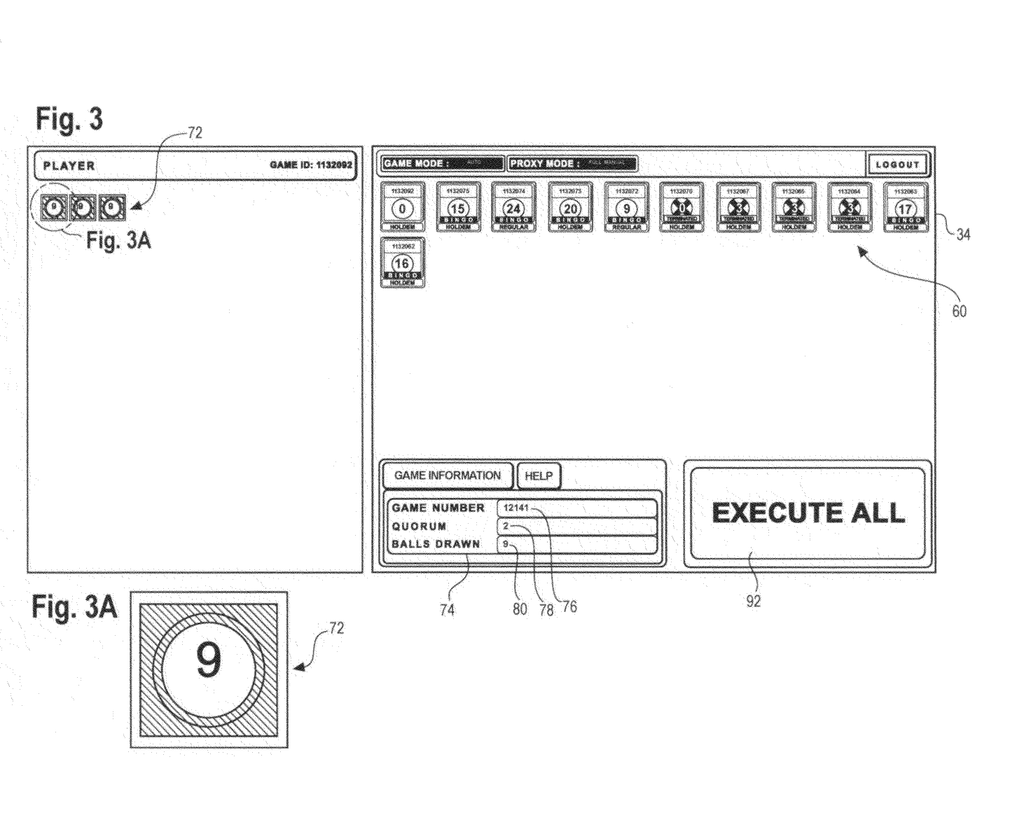

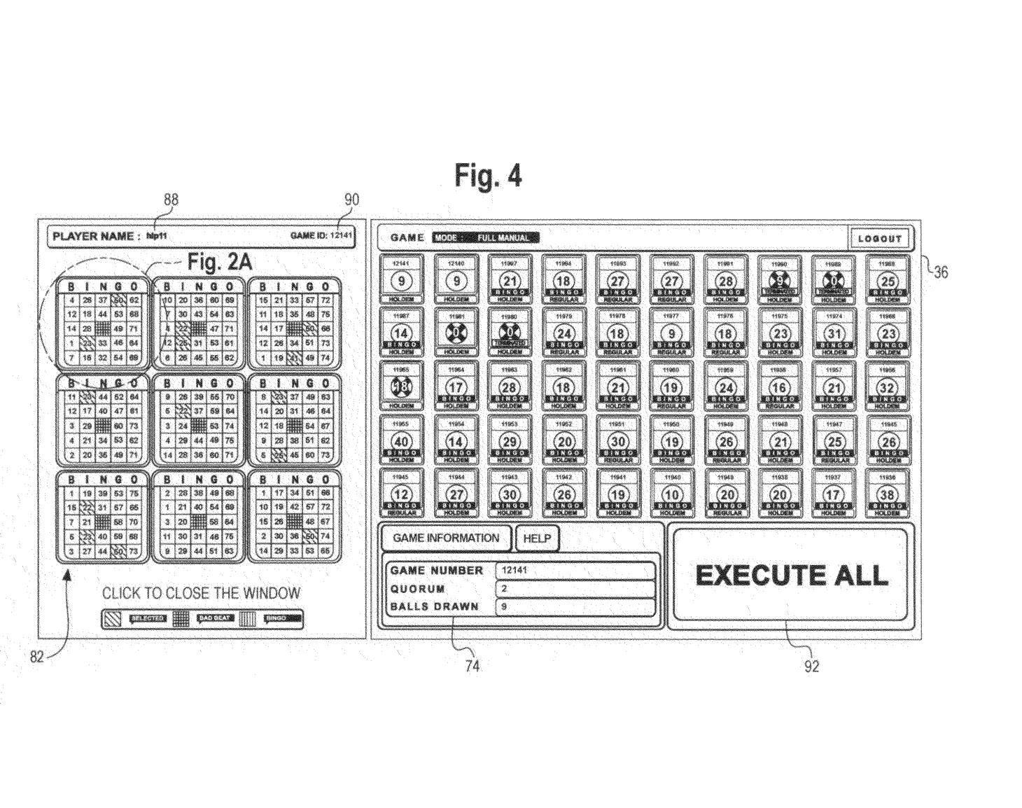

FIGS. 2 through 4A illustrate how in this embodiment, the proxy play operator 17 can continually assist with the play and monitor the activity of the player terminals 18-22 by having the ability to monitor using an electronic proxy player station display 30 on the proxy terminal 14 and view the digital bingo cards for each remote game participant as well as transmitting player instructions to the game controller 10. In the preferred embodiment, each remote game participant is represented as one of a number of small windows/boxes displayed on the screen of the electronic proxy player station. In the embodiments discussed below, the display can be a touch screen where the proxy play operator can implement various functions by tapping an icon or the operator can use a mouse and a cursor to implement a function.

FIGS. 2 and 2A illustrate a proxy help screen 32 on the display 30. In this example, the upper portion of the screen 32 includes a set of game icons 60 representing individual bingo games with the colors of the icons representing game status. As shown in detail in FIG. 2A, a large central number 62 on each game icon 60 represents the number of balls drawn in that particular game. At the top, an ID number 64 for the game the icon 60 represents is displayed. For example the number 1132074 displayed on the left hand side of the first icon is the ID for the most current game. On the bottom of the icon 60 is an indication 66 of the status of the game as to whether a bingo has been declared or the game terminated as well as an indication 68 of the type of game. As shown in the left bottom portion of the screen 32, in response to a tap on a “HELP” button 70, a list of icon colors is provided that can, for example, include: gray indicating a quorum for the game has not been filled; green to indicate it is a “Hold'em” game; blue to indicate that the game is being played; orange to indicate that the players are ready for the next ball; magenta indicating that a bingo has been declared; red with an “X” to indicate that connection between the player terminals 18-22 and the central game controller 10 has been lost; light blue to indicate that it is a regular bingo game to be played; and dark orange with an “X” to indicate that the game was terminated.

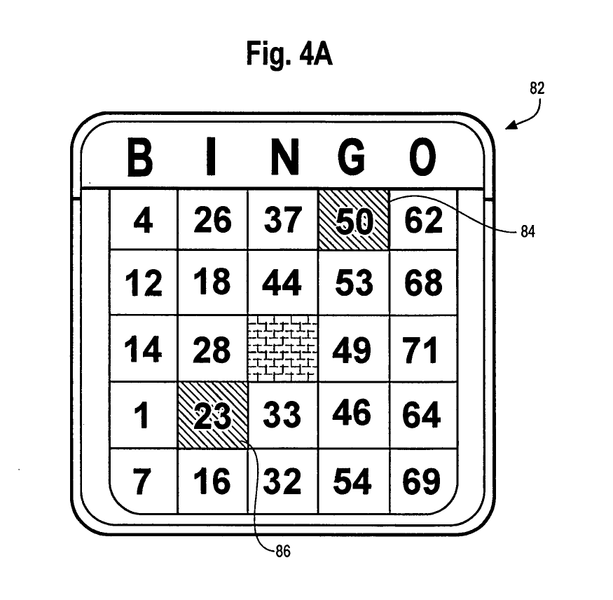

FIGS. 3 and 3A depict a proxy game screen 34. On the upper right hand side of the screen are the game icons 60 and on the left hand side of this screen 34 are a set of three player icons 72 which represent the three players in this particular game. A detailed view of one of the icons 72 is shown in FIG. 3A. By tapping on the player icons 72 a display of a player's bingo cards can be generated on the display 30 as shown in FIG. 4. Along with the game icons 60 on the upper right hand side of the screen 34, an information box 74 is displayed on the lower right side of the screen that shows the current game number 76, the number of players 78 in the quorum and the number of balls 80 that have been drawn in the game.

FIGS. 4 and 4A depict a proxy player screen 36. On the upper right hand side of the screen are the game icons 60. Above on the left hand side of this screen 36 are displayed a set of nine bingo cards 82 that are in the game for one of the players with the symbols on the card, in this case 23 and 50, corresponding to balls that have been dropped daubed in color as shown at 84 and 86. This display can be generated by the proxy operator 17 tapping on one of the player icons 72 shown in screen 34 and provides the proxy operator 17 a mechanism for viewing the status of a player's cards. Above the bingo card display is a heading that includes the player's name or ID 88 and a display 90 of the game number.

In the preferred embodiment most of the screens generated on the display 30 include an execute all button 92 that can be seen on the screens 32-36. As an illustration of how the proxy terminal 14 can control a game, during the game after each three ball drops, for example, the players are required to pay for each bingo card that they want to remain in the game. In this specific embodiment, they can select the cards they want to continue in the game using their player terminals 18-22. This information is transmitted to the central game controller 10 through the proxy terminal 14 via the communication lines 24-28 and 12. When all of the players in the game have made their selections, the central game controller 10 sends a signal to the proxy terminal 14 that causes the execute all button 92 to flash green. The operator 17 then can tap the execute all button that signals the central game controller over the line 12 to complete the card purchase transactions and continue the game with another series of ball drops. In this manner the proxy operator 17 can use the proxy terminal 14 to directly control the operation of the game on behalf of the players using the player terminals 18-22. Again, in the preferred embodiment, the players using the player terminals 18-22 located outside of the geographical area 16 will not be able to control the bingo game being operated on the central game controller.

In one embodiment, the proxy play operator 17 can view a particular remote game participant's digital bingo cards by clicking on that remote game participant's icon on, for example, the screen 34. When a remote game participant completes selecting his instructions for each round of a bingo game, the associated electronic proxy player station screen icon will turn green. The proxy play operator 17 can be provided with the ability to tap or click an icon on one of the screens 32-36 thereby producing a drop down menu of further actions with respect to that particular remote game participant that the proxy play operator 17 can choose from where unusual circumstances might warrant action such as loss of communication with the player terminals 18-22. In this case, after all remote game participant screen icons on the electronic proxy player station 14 turn green, the proxy play operator 17 can execute the purchase of the digital bingo cards for all the remote game participants on the electronic proxy player station 14 by clicking or touching the execute all button or icon 92 on one of the screens 32-36 of the electronic proxy player station 14.

In addition, as each round of three ball draws for the game is completed, the proxy play operator 17 can click or touch the electronic proxy player station screen to daub each digital bingo card displayed in each remote game participant's terminal 18-22. Here, when one or more of the remote game participants' displays flash on the screen when they have a bingo game winning pattern, the proxy play operator 17 can click or touch a bingo button on a proxy player terminal screen such as screen 36 to declare “bingo”.

It should be noted that the proxy terminal 17 described above allows its operation to be transparent or invisible to a player using one of the player terminals 18-22 to play a bingo game. In the embodiments described above, it is preferable that no information be provided to the player indicating that game data or instructions generated by a player are flowing through the proxy terminal 14 or that the proxy terminal operator 17 is transmitting game instructions to the game controller 10.

Preferably, the proxy play communication as indicated by lines 24-28 between the remote game participant and the proxy play operator will be conducted using the Tunnel VPN which securely tunnels through the Internet. Typically this type of network uses technologies such as firewalls, proxy servers, passwords, secured and encrypted data packets, and routers. In the context of Internet addressing architecture, a “private network” is a network that uses private IP address space, following the standards set by RFC 1918 and RFC 4193. Thus, the Tunnel VPN will be separate and distinct from “the Internet” even though it may share some infrastructure with the Internet. In this regard, the Tunnel VPN is a form of communication that utilizes secured connections over a publically available network. Such Tunnel VPNs are designed to allow access to users on either end of the network, and are point-to-point connections segregated from the Internet.

In System as described above the following steps can be used in order to access the Game System's closed network and play a bingo game:
1. Upon accessing the tribe's web address, the remote user on player terminals 18-22 will be directed to download Tunnel VPN client software. Once the remote user has completed an application and identification verifications, he will be admitted to the Tunnel VPN and will be unable to communicate outside the Tunnel VPN until he logs out of it.
2. An SSL certificate will be generated to encrypt all communications between the Game System 10, proxy terminal 14 and the remote user 18-22.
3. As the remote user logs in he will either be verified or denied access as an authorized game participant by a game system database server.
4. Once an authorized remote game participant starts using the Game System 10 he is using a secured client server.
5. At pre-set intervals, the client server talks securely to the authorized remote game participant.
6. If the client server doesn't receive a timely response because network connection is lost or the authorized remote game participant closes his browser the pre-authorized proxy player instructions take over.
7. If the authorized remote game participant logs out all of his cards are dropped and his game session is for that remote game participant.

Upon completing registration, establishing the proxy play operator settings, and setting up banking deposit and withdrawal information, a remote game participant is ready to start using the Game System 10. Once logged in, the remote game participant selects the money denomination per digital bingo card, the number of digital bingo cards desired to be played, and the Game System 10 checks to make sure the remote game participant has enough credits to purchase the digital bingo cards selected. If the remote game participant has enough credits then the Game System 10 will put the remote game participant into a multiplayer bingo game which requires a set number of minimum players or quorum to start the game. The minimum number of bingo players to start a game generally requires at least two players in all games.

In this particular embodiment, after the minimum number of bingo players to start a game is met, the Game System 10 will give each remote game participant up to nine digital bingo cards, that can be be played by the proxy player operator 17 on behalf of the remote game participant. Each common game of bingo can be played using one 18,000 digital card deck with 110 duplicates of digital cards. Here, the remote game participant will have a given amount of time to direct the proxy player operator 17 to fold any or all cards the remote game participant desires. The remote game participant will be able to view the digital bingo cards on his player terminal 18-22 that can include a PC, tablet or smart phone device via his secured connection 24-28 to the Game System 10 located in a licensed gaming facility. The remote game participant can for instance view on his player terminal 18-22 one or more of the following: a digital display of his digital bingo cards, the three ball draw in each round, a “ball grid” representing the balls drawn in all rounds of the bingo game, the “jackpot” amount to be won on a “4 Ball” bingo, prize amount, time remaining in the round, active players, game number and account balance, along with other information. Once the initial digital bingo card distribution sequence is complete, the Game System 10, using an “electronic bingo blower” component for example, can draw a round of three (3) balls one at a time, which will be displayed on the player terminals 18-22 for the remote game participant to see. Every time a ball is selected, the digital bingo cards displayed on the remote game participant's screen are clearly marked with the number that will be daubed once the proxy player operator 17 takes action to direct the Game System 10 to daub or mark the cards. After each ball is drawn the Game System 10 checks for a prize winning “bingo” pattern, which is any straight line or four corner bingo. If no remote game participant's cards indicate a prize winning “bingo” pattern after each three ball round is drawn, each remote game participant has a given amount of time to instruct the proxy player operator 17 to hold the digital bingo cards he wants to continue to play or drop cards he does not want to play. The remote game participant must pay again for every digital bingo card kept in order to continue to the next three ball draw round. In this embodiment, if the remote game participant holds at least one digital bingo card, the remote game participant will be able to continue the bingo game to the next round. If the remote game participant folds all his digital bingo cards, his game session will be terminated and the player will not be considered for further rounds. This process repeats until there is a winner or winners of declared prize winning “bingo” patterns.

In this example, prizes for winning “bingo' patterns are paid based upon the denomination the remote game participant selected, the number of bingo cards in the game and the number of balls drawn to obtain bingo. For example, a “4 Ball” bingo will hit the jackpot, but any bingo produced after 15^{th} ball has been drawn will win some minimum prize. All prizes tables will be clearly displayed and are completely configurable by the game administrator for the gaming facility conducting the bingo game.

Moreover, the Game System can utilize a near miss payout, as described in U.S. patent application Ser. No. 13/507,344 that rewards all remote game participants that are one number away from a winning “bingo” pattern when a bingo has been declared. This feature increases the number of winning experiences for each remote game participant far more than when playing more common types of bingo games.

We claim:

1. A video bingo gaming apparatus for use by a plurality of players comprising:
a plurality of player operated terminals physically located outside of a predetermined geographical area;
a system controller, located inside said predetermined geographical area, that includes a pay structure, effective to generate a plurality of bingo cards having a plurality of symbol patterns and wherein one or more bingo game winners are determined by said system controller according to one or more of a predetermined symbol patterns of said symbol patterns on said cards and said system controller is effective to determine a bingo prize value using said pay structure; and
a proxy terminal, located inside said predetermined geographical area, operatively connected to said system controller and said player operated terminals, including a display effective to display on one or more bingo cards generated by said system controller and a set of human operated controls effective to transmit a player instruction for the purchase of bingo cards received from said player operated terminals to said system controller.

2. The system of claim 1 wherein at least one of said player operated terminals is physically located outside said predetermined geographical area.

3. The system of claim 1 wherein said player operated terminals can only transmit said player instruction to said proxy terminal.

4. The system of claim 3 wherein said player terminals can only communicate with said system controller through said proxy terminal.

5. The system of claim 3 wherein said player instructions require a proxy terminal operator to initiate on said proxy terminal the transmission of said player instruction from said proxy terminal to said system controller.

6. The system of claim 5 wherein said proxy terminal wherein said display is also effective to display the status of said player instructions and an instruction control effective for said initiation of said player instruction from said proxy terminal to said system controller.

7. The system of claim 6 wherein said instruction control includes an execute button displayed on said display.

8. The system of claim 1 wherein said proxy terminal is connected to said player operated terminal by a tunnel VPN and said system controller is not connected to said tunnel VPN.

9. The system of claim 1 wherein the operation of said proxy terminal is transparent to a player operating said player terminal.

10. The system of claim 9 wherein no indication that said proxy terminal exists is transmitted to said player terminal.

11. A proxy terminal for use with a bingo gaming system having a central controller and a plurality of player terminals comprising:
a processor including an internet enabled digital computer or server;
a display operatively connected with said processor;
a set of terminal controls;
a player communication circuit associated with said processor and adapted to receive and transmit information from one or more of the player terminals;
a game controller communication circuit associated with said processor adapted receive and transmit information from the central game controller; and
a set of control logic associated with said processor for displaying a set of bingo game status information on said display and for permitting a human operator to transmit player instructions from said player terminals to said processor utilizing said terminal controls.

12. The terminal of claim 11 wherein said communication circuit is adapted to communicate with a nonpublic internet communication system.

13. The terminal of claim 12 wherein said nonpublic internet communication system is a tunnel VPN.

14. The terminal of claim 11 wherein said player instructions include an instruction to purchase the right to retain one or more bingo cards in a game.

15. The terminal of claim 14 said instruction to purchase is represented by an icon on said display and said instruction to purchase is executed by said operator tapping or clicking said icon.

16. The terminal of claim 11 wherein said display is adapted to display the status of one or more bingo cards for selected players in a game.

17. The terminal of claim 11 wherein said display is adapted to display the status of a plurality of bingo games.

18. The terminal of claim 11 wherein said processor is configured to retain a plurality of player instructions that can be used by said operator to continue playing a game in the event communication is lost with said player terminals.

19. A method of permitting a plurality of players to play an online bingo game comprising the steps of:
locating a game controller within a predetermined geographical area;
locating a proxy terminal outside said predetermined geographical area;
permitting the players use player terminals to purchase one or more bingo cards by transmitting instructions through said proxy terminal to said game controller;
displaying the status of the game and said bingo cards on said proxy terminal;
permitting said players to transmit instructions to retain selected ones of said bingo cards in the game through said proxy terminal to said game controller;
displaying an indication on said proxy terminal that at least a portion of the players in the game have selected bingo cards for retention in the game; and
permitting a human operator of said proxy terminal to operate an execute control on said proxy terminal that is effective to cause said game controller to retain said selected bingo cards in the game.

20. The method of claim 19 including the steps of transmitting play default instructions to said proxy terminal and permitting said human operator to execute said default instructions in the event communication is lost between said player terminals and said proxy terminal.
